(19) United States
(12) Patent Application Publication
(10) Pub. No.: US 2010/0096043 A1
(43) Pub. Date: Apr. 22, 2010

(54) High Temperature Solder Materials

(75) Inventors: Patrick F. McCluskey, Ellicott City, MD (US); Pedro Quintero, Mayaguez, PR (US)

Correspondence Address: EDELL, SHAPIRO & FINNAN, LLC, 1901 RESEARCH BLVD, SUITE 400, ROCKVILLE, MD, 20850-3164, US

(73) Assignee: UNIVERSITY OF MARYLAND, COLLEGE PARK, College Park, MD (US)

(21) Appl. No.: 12/500,948

(22) Filed: Jul. 10, 2009

Related U.S. Application Data
(63) Continuation of application No. PCT/US08/51590, filed on Jan. 22, 2008.
(60) Provisional application No. 60/885,997, filed on Jan. 22, 2007.
(60) Provisional application No. 60/891,763, filed on Feb. 27, 2007.

(51) Int. Cl. B23K 35/34; B23K 35/24

(52) U.S. Cl. 148/24; 148/23

(57) ABSTRACT

A solder material is formed utilizing a transient liquid phase sintering process, where a precursor material is first formed. The precursor material comprises a plurality of metal particles including a first metal having a first melting point temperature and a second metal having a second melting point temperature, the first melting point temperature being greater than the second melting point temperature. The precursor material is heated to a process temperature (Tₚ) that is greater than the second melting point temperature and less than the first melting point temperature, and the precursor material is isothermally held at the process temperature (Tₚ) for a preselected holding period so as to form a metal alloy material having a melting point temperature that is greater than the process temperature. The solder material can be used to bond two components together in a device specified for use at an application temperature (Tₐ), where Tₐ/Tₚ>1.

### CROSS-REFERENCE TO RELATED APPLICATIONS

This application is a continuation of U.S. patent application Ser. No. PCT/US08/51590 (filed Jan. 22, 2008, presently pending), which application claims priority from U.S. Provisional Patent Applications Ser. Nos. 60/885,997 (filed: Jan. 22, 2007, presently lapsed) and 60/891,763 (filed: Feb. 27, 2007, presently lapsed), all of which applications are incorporated herein by reference in their entireties.

### STATEMENT REGARDING FEDERALLY SPONSORED RESEARCH OR DEVELOPMENT

This invention was made with Government support under W911NF0520052 awarded by Army Research Laboratory. The Government has certain rights in the invention.

### BACKGROUND OF THE INVENTION:

1. Field of the Invention

The present invention relates to solder materials for use in a bonding or attachment connection of two components.

2. Description of Related Art

The use of bonding materials for attaching or connecting two or more components to each other is required for a number of different technologies, including the joining of components internal to an electronic package and/or the joining of packaged components to a substrate or circuit board (e.g., semiconductor components) for electronic and/or other technologies.

One well known attachment process is a soldering process, in which a metal alloy solder material is melted, reflowed and then solidified to create an attachment or bond between two components. In such a conventional soldering process for the manufacture of a device, a solder material must be selected that has a sufficient melting point to render the solder material stable so as to maintain its bonding integrity at the application temperature range through which the device is designed and specified for use. In particular, to avoid melting of the solder material during use of the device, a solder material is typically chosen having a melting point temperature (Tₘ) that is higher than the specified application temperature (Tₐ) for the device. In addition, in certain device manufacturing processes (e.g., processes which utilize cascade soldering), an initial solder material must have a sufficient melting point temperature to avoid re-melting during subsequent process steps.

In applications in which a solder material is selected with a melting point greater than the application temperature, the process temperature (Tₚ) used for achieving a bonding connection between two components using the solder material is typically selected to be at least about 30° C. greater than the melting point temperature (i.e., Tₚ≧Tₘ+30° C.>Tₐ). For example, for a device that is rated to operate at temperatures of at least 300° C.

(Tₐ=300° C.), it is desirable to use a solder material with a Tₘ of at least about 370° C. and a Tₚ of about 400° C.

The high processing temperatures that are required for manufacturing devices with high application temperatures may require customized equipment to be used in the manufacturing process when using solder materials that utilize conventional soldering attachment methods, and all of the manufacturing materials must be able to handle such high processing temperatures. In addition, depending upon the differences in coefficient of thermal expansion (CTE) between different materials used to construct the device, the stresses that result from CTE differences between two or more materials can result in construction defects during the cool down of the device from the process temperature(s) to ambient temperatures and lead to potential reliability problems.

Another type of attachment process that can be employed to connect two or more components together in an electronic or other device is a solid-solid sintering process, in which a solid bonding material is formed from metallic particles (such as silver). Such a sintering process utilizes high temperatures and external pressures (as high as 40 Mpa) to adhere and fuse the particles together so as to form a solid material or layer. One serious problem with using a conventional sintering process is that the high pressures that are required to adhere and fuse the particles together can result in fracturing of portions of the component (e.g., cracking of a substrate or die), while the use of lower pressures can result in weakened or inconsistent bonding between components.

Yet another approach for a bonding material for electronic and other devices is the use of a polymer matrix as the bonding material, where the polymer matrix includes metal particles embedded within the matrix. However, such polymer matrices known in the art tend to have transition temperatures (e.g. melting points, glass transition temperatures) which approach or are below the typical application temperatures of certain electronic devices, and this can result in instabilities, decomposition, or melting of the polymer matrix bonding material during use of the device.

Thus, it would be desirable to provide a bonding material that is effective for bonding components together in devices (such as electronic devices) and which is reliable and maintains its bonding integrity at high application temperatures of the devices while facilitating ease of manufacture of the devices.

### SUMMARY OF THE INVENTION

In accordance with the invention, a solder material is formed utilizing a transient liquid phase sintering process. A precursor material is first formed comprising a plurality of metal particles including a first metal having a first melting point temperature and a second metal having a second melting point temperature, the first melting point temperature being greater than the second melting point temperature. The precursor material is heated to a process temperature (Tₚ) that is greater than the second melting point temperature and less than the first melting point temperature, and the precursor material is isothermally held at the process temperature (Tₚ) for a preselected holding period so as to form a metal alloy material having a melting point temperature that is greater than the process temperature.

Preferably, the precursor material further includes a binding agent combined with the metal particles, such that the precursor material is in the form of a paste.

The solder material can be used to bond two components together in a device specified for use at an application temperature (Tₐ) preferably of at least about 180° C., where Tₐ/Tₚ can be greater than 1.

Any suitable combination of first and second (and, optionally, further) metals can be provided to form a resultant metal alloy in which the melting point temperature of the resultant metal alloy solder material is greater than the process temperature at which the metal alloy is formed. For example, first metals can include silver (Ag), copper (Cu) and gold (Au), and second metals can include indium (In), gallium (Ga), and tin (Sn).

In detail, the invention provides a method of forming a solder material, the method comprising:
forming a precursor material comprising a plurality of metal particles including a first metal having a first melting point temperature and a second metal having a second melting point temperature, the first melting point temperature being greater than the second melting point temperature;
heating the precursor material to a process temperature (Tₚ) that is greater than the second melting point temperature and less than the first melting point temperature; and
isothermally holding the precursor material at the process temperature (Tₚ) for a preselected holding period so as to form a metal alloy material including the first and second metals, wherein the metal alloy material has a melting point temperature that is greater than the process temperature.

The invention further pertains to the embodiment of such method, wherein the precursor material further includes a binder material combined with the metal particles to form a paste material. The invention further pertains to the embodiment of such method wherein the binder material comprises a flux material.

The invention further pertains to the embodiment of such methods wherein the binder material is present in the precursor material in an amount from about 5% to about 15% by weight of the precursor material.

The invention further pertains to the embodiment of such methods wherein the particle sizes of metal particles within the precursor material are no greater than about 50 microns, or no greater than about 10 microns.

The invention further pertains to the embodiment of such methods wherein the amount of the first metal in the precursor material is from about 30% to about 95% by total weight of metal particles within the precursor material.

The invention further pertains to the embodiment of such methods wherein the first metal is one of Ag, Cu, and Au. The invention further pertains to the embodiment of such methods wherein the second metal is one of In, Sn, and Ga. The invention particularly pertains to the embodiment of such methods wherein the first metal is Ag and the second metal is In. The invention further pertains to the embodiment of such methods wherein the precursor material includes Ag in an amount of about 75% by weight of metal particles within the precursor material and In in an amount of about 25% by weight of metal particles within the precursor material.

The invention further pertains to the embodiment of such methods wherein the process temperature (Tp) is from about 160° C. to about 180° C., or wherein the process temperature (Tp) is from about 200° C. to about 400° C., or wherein the process temperature (Tp) is from about 250° C. to about 300° C.

The invention further pertains to the embodiment of such methods wherein the precursor material is heated to the process temperature (Tp) at a heating rate from about 0.4° C./second to about 2° C./second.

The invention further pertains to the embodiment of such methods wherein the precursor material is isothermally held at the process temperature (Tp) for a holding period from about 20 minutes to about 90 minutes or wherein the precursor material is isothermally held at the process temperature (Tp) for a holding period from about 45 minutes to about 60 minutes.

The invention further pertains to the embodiment of such methods wherein the precursor material further includes metal particles of a third metal having a third melting point temperature that is less than the first melting point temperature, and the formed metal alloy material further includes the third metal.

The invention further pertains to the embodiment of such methods wherein the melting point of the metal alloy material is at least about 250° C.

The invention further pertains to a method of manufacturing a device including forming a solder joint that bonds two components together, the method comprising:
providing a first component and a second component to be bonded together;
applying a precursor material to a surface of the first component, the precursor material comprising a first metal having a first melting point temperature and a second metal having a second melting point temperature, the first melting point temperature being greater than the second melting point temperature;
applying the second component to the surface of the first component including the precursor material;
heating the precursor material to a process temperature (Tₚ) that is greater than the second melting point temperature and less than the first melting point temperature; and
isothermally holding the precursor material at the process temperature (Tₚ) for a preselected holding period so as to form a metal alloy material that bonds the first component to the second component, the metal alloy material having a melting point temperature that is greater than the process temperature.

The invention further pertains to the embodiment of such method wherein the melting point temperature of the formed metal alloy material is greater than a maximum application temperature (Ta) at which the device is specified for use, the application temperature (Ta) is at least about 180° C., and Ta/Tp>1, or wherein the melting point temperature of the formed metal alloy material is greater than a maximum application temperature (Ta) at which the device is specified for use, the application temperature (Ta) is at least about 400° C., and Ta/Tp>1, or wherein Ta/Tp>2.

The invention further pertains to the embodiment of such methods wherein the first metal is one of Ag, Cu, and Au. The invention further pertains to the embodiment of such methods wherein the second metal is one of In, Sn, and Ga. The invention particularly pertains to the embodiment of such methods wherein the first metal is Ag and the second metal is In.

The invention further pertains to the embodiment of such methods wherein the device comprises an electronic device.

The invention further pertains to the embodiment of such methods wherein the first component comprises one of a board, a substrate and an electronic component, and the second component comprises an electronic component.

The invention further pertains to a precursor material used to form a metal alloy solder material, the precursor material comprising metal particles combined with a binder material, the metal particles including a first metal having a first melting point temperature and a second metal having a second melting point temperature, the first melting point temperature being greater than the second melting point temperature, wherein the metal particles have sizes no greater than about 50 microns or wherein the metal particles have sizes no greater than about 1 micron.

The invention further pertains to the embodiment of such precursor materials wherein the amount of binder material in the precursor material is from about 5% to about 15% by weight of the precursor material. The invention further pertains to the embodiment of such precursor material wherein the binder material comprises a flux material.

The invention further pertains to the embodiment of such precursor materials wherein the amount of the first metal in the precursor material is from about 30% to about 95% by total weight of metal particles within the precursor material.

The invention further pertains to the embodiment of such precursor materials wherein the first metal is one of Ag, Cu, and Au. The invention further pertains to the embodiment of such precursor materials wherein the second metal is one of In, Sn, and Ga. The invention further pertains to the embodiment of such precursor materials wherein the precursor materials include Ag in an amount of about 75% by weight of metal particles within the precursor material and In in an amount of about 25% by weight of metal particles within the precursor material.

The invention further pertains to a solder material comprising a metal alloy formed from a plurality of metals including a first metal having a first melting point temperature and a second metal having a second melting point temperature, the first melting point temperature being greater than the second melting point temperature, wherein the metal alloy is formed by combining particles of the first and second metals and heating the metal particles to a process temperature to form the metal alloy, wherein the metal alloy has a melting point temperature that is greater than the second melting point temperature and the process temperature.

The invention further pertains to the embodiment of such solder material wherein the first metal is in the solder material from about 30% to about 95% by total weight of the solder material. The invention further pertains to the embodiment of such solder materials wherein the first metal is one of Ag, Cu, and Au. The invention further pertains to the embodiment of such solder materials wherein the second metal is one of In, Sn, and Ga. The invention particularly pertains to the embodiment of such solder materials wherein the first metal is Ag and the second metal is In. The invention further pertains to the embodiment of such solder materials wherein Ag is in the solder material in an amount of about 75% by weight of the solder material and In is in the solder material in an amount of about 25% by weight of the solder material.

The invention further pertains to the embodiment of such solder materials wherein the melting point of the metal alloy is at least about 250° C.

The invention further pertains to a device comprising a first component bonded to a second component with the above-described solder material.

The invention further pertains to the embodiment of such devices wherein the first metal is one of Ag, Cu, and Au. The invention further pertains to the embodiment of such devices wherein the second metal is one of In, Sn, and Ga. The invention particularly pertains to the embodiment of such devices wherein the first metal is Ag and the second metal is In.

The invention further pertains to the embodiment of such devices wherein the device comprises an electronic device. The invention particularly pertains to the embodiment of such devices wherein the first component comprises one of a board, a substrate and an electronic component, and the second component comprises an electronic component. The invention further pertains to the embodiment of such devices wherein the electronic component for at least one of the first and second components comprises a semiconductor chip.

The above and still further features and advantages of the present invention will become apparent upon consideration of the following detailed description of specific embodiments thereof, particularly when taken in conjunction with the accompanying drawings.

### BRIEF DESCRIPTION OF THE DRAWINGS:

FIG. 1 is a plot of an Ag—In equilibrium phase diagram, which shows the melting point of various Ag—In compositions.

FIG. 2 is a SEM photograph of Ag particles in a powder used to form a solder material.

FIG. 3 is a SEM photograph of In particles in a powder used to form a solder material.

FIGS. 4A-4B are plots from a differential scanning calorimeter (DSC) for a TLPS process in forming a solder material from a Ag—In solder paste with a Tₚ of 250° C. (FIG. 4A, holding time of 1 minute; FIG. 4B, holding time of 60 minutes).

FIG. 5 is a SEM photograph of a Ag—In solder joint formed on a substrate utilizing a TLPS process.

FIG. 6 is a plot of data showing low melting point In rich phase in the metal alloy solder material formed using a TLPS process with different pastes and utilizing different holding times during the TLPS process.

### DETAILED DESCRIPTION OF THE INVENTION:

In accordance with the present invention, a high temperature solder material is provided that combines at least two metals including a first metal having a melting point at a first temperature and a second metal having a melting point at a second temperature that is significantly lower than the first temperature, where the solder material is formed using a transient liquid phase sintering (TLPS) process. In the TLPS process, metal particles used to form the solder material are heated and then held isothermally for a sufficient time at a process temperature that is above the second temperature but well below the first temperature to form a metal alloy solder material that achieves a bonding or attachment connection between at least two components. Upon forming the bonding connection, the resultant melting point of the solidified metal alloy solder material is much greater than the second temperature (i.e., greater than the melting point of the second metal) such that the application temperature (Tₐ) at which the solder material can be used and maintain its bonding integrity (e.g., the application temperature at which a device is intended or specified for use) is significantly greater than the process temperature used to form the bonding connection.

As used herein, the term melting point temperature (Tₘ) refers to the temperature at which a metal or a metal alloy begins to undergo a phase change from a solid to a liquid. The term process temperature (Tₚ) refers to the temperature or temperature range at which a metal alloy solder material is formed from a precursor material including metal powders and/or achieves a bonding or attachment connection between two components during the manufacture of a device. The term application temperature (Tₐ) refers to a temperature at which the high temperature metal alloy solder material can be used without melting and without a significant degradation or loss of its integrity with respect to bonding two components together. In particular, the application temperature (Tₐ) refers to the temperature or temperature range in which a device including at least one bonding connection formed utilizing the high temperature solder material of the invention is rated or specified for use. The melting point temperature (Tₘ) of the metal alloy material formed in accordance with the invention is preferably at least about 50° C. above the process temperature (Tₚ) at which the metal alloy material is formed. In addition, the melting point temperature (Tₘ) of the metal alloy material formed in accordance with the invention is at least about 30° C. greater than the application temperature (Tₐ).

The high temperature solder material can be formed with any suitable metal alloy material that includes a first metal with a melting point temperature (Tₘ) that is sufficiently higher than at least another or second metal and is further greater than the process temperature (Tₚ) used to form the metal alloy material. Further, the melting point temperature (Tₘ) of the first metal is preferably greater than the application temperature (Tₐ) of the device in which the solder material is to be utilized such that, during processing to form the alloy, the second metal is melted to facilitate diffusion between the solid and liquid phase metal portions thus forming an alloy material having a resultant Tₘ that is greater than Tₐ and Tₚ.

Suitable metals with higher melting point temperatures that can be used as the first metal described above in forming the high temperature solder material of the invention include silver (Ag), copper (Cu) and gold (Au). Suitable metals with lower melting points than a first metal (i.e., melting points that are lower than the highest melting point metal) which can be used to form the metal alloy material of the invention include indium (In), gallium (Ga), and tin (Sn). For example, first metal-second metal combinations that can be used to form alloys for the high melting point solder material include, without limitation, Ag—In, Ag—Sn, Ag—Ga, Cu—Sn, Cu—Ga, Au—In, Au—Sn. In addition, combinations of three or more metals can be utilized, so long as at least the highest melting point metal is greater than the process temperature (Tₚ) used to form the metal alloy and at least the lowest melting point metal is less than such process temperature (Tₚ).

A suitable combination of higher and lower melting point metals that can be used to form the metal alloy of the high temperature solder material of the invention can be selected such that the resultant melting point temperature (Tₘ) of the metal alloy is greater than the processing temperature (Tₚ) used to form the alloy and the bonding connection (i.e., Tₘ>Tₚ, or Tₘ/Tₚ>1). Preferably, the high temperature metal alloy material formed has a Tₘ value of at least about 250° C. More preferably, the high temperature metal alloy material formed has a Tₘ value of at least about 400° C.

In addition, the high temperature solder material can be formed such that the process temperature (Tₚ) is less than the application temperature (Tₐ). As further described below, high temperature solder materials described herein can be formed such that Tₘ>Tₐ>Tₚ, where Tₐ is at least about 180° C. and where Tₐ/Tₚ>1.

Preferably, the high temperature solder materials are formed from metal powder or particles having controlled particle sizes (e.g., diameters) and shapes (e.g., round or irregular shaped). The amount of high melting point metal that can be present in the resultant metal alloy solder material can be in the range from about 30% to about 95% by total weight of the metal in the solder material. For example, in a two metal solder alloy with a first metal that is Ag, Cu or Au and a second metal that is In or Sn, the amount of first (high melting point) metal to second (lower melting point) metal can vary from 30/70, 40/60, 50/50, 60/40, 70/30, 80/20, 90/10 and 95/5 (weight percentages) based upon the total weight of the alloy metal within the solder material. For example, it has been determined that, for an Ag—In metal alloy combination formed in accordance with the invention, weight percentages of 60/40, 70/30, 80/20, 90/10 and 95/5 (weight percentage of Ag/weight percentage of In) can be utilized to form an effective metal alloy solder joint.

Metal particles in the form of powders can be combined to form a generally uniform mixture, where the powder mixture is a precursor material that is used to form the high temperature solder alloy material. The metal particles are preferably substantially pure and have particle sizes (e.g., diameters) within a range from about 50 nanometers (nm) to about 50 micrometers (microns), preferably from about 500 nanometers to about 25 microns, and more preferably from about 1 micron to about 10 microns. In an exemplary embodiment, the metal particles can include size ranges that are no greater than about 1 micron. A particle size range such as any of the ranges described above can be obtained, for example, in any conventional or other suitable manner. For example, metal particles with specified size ranges can be obtained using sieving or screening techniques with one or more mesh screens of different mesh sizes.

The metal particles can have geometric profiles or shapes that range from generally rounded and spherical to ligamental or irregular shaped and even elongated or flake-shaped. For generally rounded and spherical particle shapes, the particle sizes can be generally characterized by particle diameter, whereas a largest dimension (e.g., length or width) can be used to characterize ligamental or irregular shaped particles. Preferably, at least the lower melting point metal particles that are utilized to form the powder mixture (e.g., In or Sn) are irregular shaped or elongated or flake shaped so as to provide a higher surface area per particle to enhance melting and diffusion of the metal during formation of the alloy material. In addition, the higher melting point metals can also be provided having ligamental or irregular shapes, or elongated or flake-shapes, to enhance the heating and diffusion process between metals during alloy formation.

The solder precursor material may be in the form of a mixture of loose, or compacted, powder. Alternatively, the precursor material can also include a binder material to bind the metal powder mixture and form a precursor solder paste material. The binder material can further enhance flow and diffusion of metals during processing to form the alloy. The binder material can comprise an oil that is environmentally friendly (e.g., fish oil) and is further relatively inert to the alloy formation process. The binder material can also comprise a flux material formed of a suitable activator that inhibits oxidation of the metals during the high temperature processing as well as during storage (thus enhancing storage life of the paste).

The flux material can include suitable activators, such as activators that comprise about 0.5% by volume of the flux material, where a rosin or some resin, natural or synthetic, that serves as a base or medium for the flux comprises about 75% by volume of the flux material. The rosin plays a role in the flow properties of the paste, especially at elevated temperatures, and it also provides certain physical properties, such as “tackiness”, to the paste material. The rosin provides the flux with the “body” that contributes to the ultimate rheological properties of the paste. As an example, the rosin in a rosin based flux can include abietic acid in an amount of about 34% by weight of the flux, dehydroabietic acid in an amount of about 24% by weight of the flux, and palustric acid in an amount of about 9% by weight of the flux. These natural or synthetic rosins or resins can also contribute to the activity of the flux, but additional activator may also be provided to improve the cleaning strength of the system. Activators give the flux its cleaning ability, that is, the ability to remove oxides from the surfaces being soldered. Activators can be chosen from a wide variety of chemical substances including inorganic acids and salts, amines, organic acids, and any other substance that has the ability to reduce or remove oxides and tarnish. A preferable flux material for use in forming a precursor solder paste material includes a no clean (i.e., benign and/or insubstantial amounts of flux residues) rosin mildly activated (RMA) flux, such as a commercially available RMA flux material sold under the tradename TAC Flux 007 from Indium Corporation (New York).

The formation of a solder paste with a binding material such as an RMA flux renders the solder material easy to apply and to use for forming bonding connections. For example, the solder paste material can be easily applied to a board (e.g., a circuit board), substrate or any other component surface using conventional techniques such as stencil printing or other dispensing techniques, where a second component (e.g., a semiconductor die or chip, a packaged component or other types of electronic components) is then bonded to the substrate with the solder material. As with conventional flux materials used for conventional solders, the binder material (e.g., a flux material such as a no clean RMA flux material) is substantially or entirely removed from the solder material as a result of the high processing temperatures employed to form the solder material bonding connection.

The binder material is preferably provided in an amount from about 5% to about 15% by total weight of the solder paste material, with metal powder being present in the solder paste material in a range from about 85% to about 95% by total weight of solder paste material. More preferably, the binder material is provided in an amount from about 8% to about 12% by total weight of the solder paste material, with metal powder being present in the solder paste material in an amount from about 88% to about 92% by total weight of the solder paste material.

As noted above, the metal powder mixture, or paste material (which includes the binder material with the metal powder mixture) is a precursor material that must be thermally processed to form the high temperature solder material of the invention. A transient liquid phase sintering (TLPS) process is utilized to convert the precursor material to the high melting point solder material. In this process, the precursor material is heated at a selected heating rate until a preselected holding temperature or process temperature (Tₚ) is achieved, and then held isothermally at such Tₚ for a preselected time period to ensure adequate diffusion between the metals to form the alloy. The Tₚ is set to a suitable value that lies between the Tₘ value of at least the highest melting point metal and the Tₘ value of at least the lowest melting point metal in the precursor material, where Tₚ is preferably at least about 30° C. higher than the Tₘ value of at least the lowest melting point metal. The precursor material is held isothermally at the process temperature (Tₚ) for a sufficient time period so as to facilitate a phase change of at least the lowest melting point metal to a liquid and to permit sufficient diffusion to occur to initiate the formation of the metal alloy.

During the TLPS process, the metal alloy forms at the process temperature (Tₚ) and during the holding time period as a result of diffusion between the liquid and solid metals in the composition. The diffusion between liquid and solid metals is due at least in part to capillary action or “wicking” of the liquid metal within the solid metal powder as well as concentration gradients between the different metals within the composition. The rate of melting of the lower melting point metal or metals and the diffusion of metals within the heated material can be influenced and controlled by a number of factors including, without limitation, the process temperature (Tₚ), the holding time at Tₚ, the composition and types of the metals within the overall composition, and the geometry of the particles (e.g., rounded and spherical, and non-spherical or irregular shaped particles).

While the process temperature (Tₚ) will vary based upon the combination and amounts of metals used in forming the alloy, the Tₚ value will preferably be in the range from about 160° C. to about 800° C., more preferably from about 200° C. to about 400° C., and even more preferably from about 250° C. to about 300° C. At lower Tₚ values, the holding time period will be greater in comparison to higher Tₚ values so as to ensure adequate diffusion between metals within the alloy and a lower percentage of low melting point portions within the metal alloy (i.e., percentage of portions within the alloy having a high concentration of lower melting point metals). It is preferable, however, to use a holding time in the range from about 5 minutes to about 120 minutes, more preferably about 20 minutes to about 90 minutes, and most preferably from about 45 minutes to about 60 minutes, with an exemplary holding time period being about 60 minutes. The heating rate (and, optionally, a subsequent cooling rate) can be controlled at a rate from about 0.4° C./second to about 2° C./second, with exemplary heating rates (and, optionally, a subsequent cooling rate) of about 0.5° C./second and 1° C./second.

The composition solidifies as it is being held at Tₚ for the preselected holding time period (due to diffusion between the liquid and solid metals) and the metal alloy is being formed. The resultant metal alloy that forms has a higher Tₘ value that falls between the highest and lowest Tₘ values of the metals within the composition. As noted above, the selection of a suitable metal powder precursor composition (or suitable paste precursor composition) will yield a high temperature solder material with the TLPS process having a resultant Tₘ value that is higher than Tₚ and further facilitates use of the solder material in applications in which the application temperature (Tₐ) is also higher than Tₚ (i.e., Tₐ/Tₚ>1).

When forming a solder joint with the precursor paste material and the TLPS process in accordance with the invention, a small amount of the solder material paste can be easily applied (e.g., via a stencil printing technique) to the surface of a board, substrate or other component that serves as the bonding site. The thickness of the solder material paste to be applied can vary based upon the composition of the solder paste and a particular application. However, an exemplary thickness of the solder paste material can be in the range from about 50 microns (about 2 mils) to about 254 microns (about 10 mils), preferably from about 100 microns (about 4 mils) to about 204 microns (about 8 mils). A second component can then be applied to the solder material paste layer, followed by performing the TLPS process as described above to form a solder joint with a resultant high melting point temperature (Tₘ) that exceeds the process temperature (Tₚ). The resultant metal alloy solder joint that is formed has a thickness that can be in the range from about 25 microns (about 1 mil) to about 127 microns (about 5 mils), preferably from about 50 microns (about 2 mils) to about 100 microns (about 4 mils).

As noted above, the high temperature metal alloy solder materials can be applied to any number of different surfaces (e.g., a board, substrate or component surface) to facilitate the formation of any number of different types of connections between electronic components (e.g., semiconductor die or chip components connected to each other or to a board or substrate surface, a ceramic packaged component to a board, internal and/or external interconnect structures, etc.). It is further noted that the high temperature metal alloy solder materials can also be used to connect any other types of components or devices together. For example, the high temperature metal alloy solder materials can be used to form solder joints for piping structures (e.g., water pipes) or between any other types of components to be bonded together.

The TLPS process provided in accordance with the invention differs from conventional sintering processes in at least the following manner. In conventional sintering processes, in which a solid-solid bonding of metal particles is desired, a high temperature combined with a high external pressure applied to the material is required. In the TLPS process of the present invention, the lower Tₘ metal that melts during the process provides a liquid phase that flows between the solid metal particles via capillary action, and no external pressure is required to form the alloy. This is because the liquid metal provides a wetting force that enhances densification of the composition (i.e., the wetting force of the liquid metal eliminates the requirement of external pressure). In addition, the metal liquid enhances the rate of mass transport of metals within the composition in comparison to solid-solid mass transport that occurs in conventional sintering processes.

The solder material formed in accordance with the invention provides a number of advantages over conventional solders or other bonding materials utilized to connect components together. For example, the combination of at least one high melting point metal with at least one lower melting point metal (such as the metal combinations described above) in accordance with this invention yields an alloy material with a resultant melting point (Tₘ) that is sufficiently high to facilitate use of the solder material at application temperatures (Tₐ) that are significantly higher than the Tₚ value used to form the solder material, and as such reduces the process temperature (Tₚ) required to form a bonding connection in relation to conventional re-flow solder materials. High temperature solder materials that are formed in accordance with the invention have high temperature stability at a variety of Tₐ values, including Tₐ values of at least about 180° C. For example, solder materials formed in accordance with the present invention have been demonstrated as capable for use as a bonding or attachment material in devices at Tₐ values as high as about 500° C., about 550° C., and even about 600° C. In addition, combinations of metals such as the combinations described above would be expected to form high temperature solder materials in accordance with the invention that can be used at even higher application temperatures (Tₐ values), including application temperatures as high as about 50° C. below the melting point of the highest melting point metal in the metal alloy solder material. For example, in certain metal alloy solder materials formed in accordance with the invention that include Ag (such as Ag—Sn combinations), the application temperature for such metal alloy solder materials can be as high as about 912° C. (since the melting point temperature of Ag is 962° C.).

As noted above, conventional reflow solder materials require a process temperature (Tₚ) that is greater than the melting point (Tₘ) of the solder and therefore also greater than the maximum application temperature (Tₐ) at which the conventional solder material can be used (i.e., Tₚ>Tₘ>Tₐ for a conventional solder material). Therefore, the ratio of both Tₘ/Tₚ and Tₐ/Tₚ for conventional solder materials must be less than 1 to form the solder joint and also to ensure stability and integrity of the solder joint during use of a device in which the solder joint is present.

As noted above, the high temperature solder materials formed in accordance with the invention using a TLPS process as described above are formed where the resultant melting point of the metal alloy solder is greater than the process temperature used to form the metal alloy and the solder joint (i.e., Tₘ/Tₚ>1). For example, for Ag—In combinations of metal alloy solder materials formed in accordance with the present invention, the ratio of Tₘ/Tₚ (melting point temperature of the metal alloy/process temperature at which the metal alloy is formed) can be greater than about 1.5, greater than about 2, or even greater than about 2.5.

In addition, the high temperature solder materials of the invention can be used for certain applications in which the ratio of Tₐ/Tₚ (application temperature at which metal alloy solder is used / process temperature at which the metal alloy is formed) is greater than 1. For example, the high temperature solder materials described herein can be used in devices which have Tₐ/Tₚ values that are at least about 2, with some high temperature solder materials that are formed having Tₐ/Tₚ values of about 2.5 or greater. Thus, the high temperature solder materials can be processed at much lower Tₚ values with a much greater range of Tₐ values (which facilitates a wider range of applicability) in relation to conventional reflow solders.

As further noted above, the TLPS process used to form the high temperature solder materials of the invention provides a number of advantages over conventional sintering processes including, without limitation, the advantage of eliminating the requirement for applying pressure to the material to achieve the desired densification of the metal powder during the sintering process. As noted above, the liquid metal formed during the initial stages of the TLPS process achieves the desired densification of the resultant alloy material formed without the requirement of applying pressure during the sintering process (which can be detrimental to the substrate, die or working piece to which the sintered metal material is being adhered).

In addition, it is noted that certain planar thin film deposition techniques are known in electronic device manufacturing, in which liquid phase sintering may occur during a manufacturing process at the interface between layers including different metals. However, such techniques are limited in that they require a physical or chemical vapor deposition of thin film layers at required thicknesses in order to achieve a desired diffusion between metals at layer interfaces. This is significantly more complex and time consuming in comparison to the process of the present and invention, in which a precursor solder material is simply applied to the surface of a substrate and a TLPS process is performed to achieve an effective solder joint during the manufacturing process of a device. In addition, when using a solder paste material including a flux as described above, the TLPS process does not require an oxygen free or inert atmosphere (since the flux medium protects the metals from oxidation during the TLPS process).

Having now generally described the invention, the same will be more readily understood through reference to the following Examples, which are provided by way of illustration and are not intended to be limiting of the present invention unless specified.

### EXAMPLES

The following examples demonstrate the effectiveness of forming high temperature solder materials using a TLPS process in accordance with the invention.

### Example 1

### Forming a AG—In Solder Material

A solder material was formed using silver (Ag), which has a Tₘ value of about 962° C., and Indium (In), which has a melting point of about 157° C. A precursor paste material was formed including metal powders of Ag and In combined with a no clean RMA flux material (a commercially available RMA flux material sold under the tradename TAC Flux 007 from Indium Corporation (New York)).

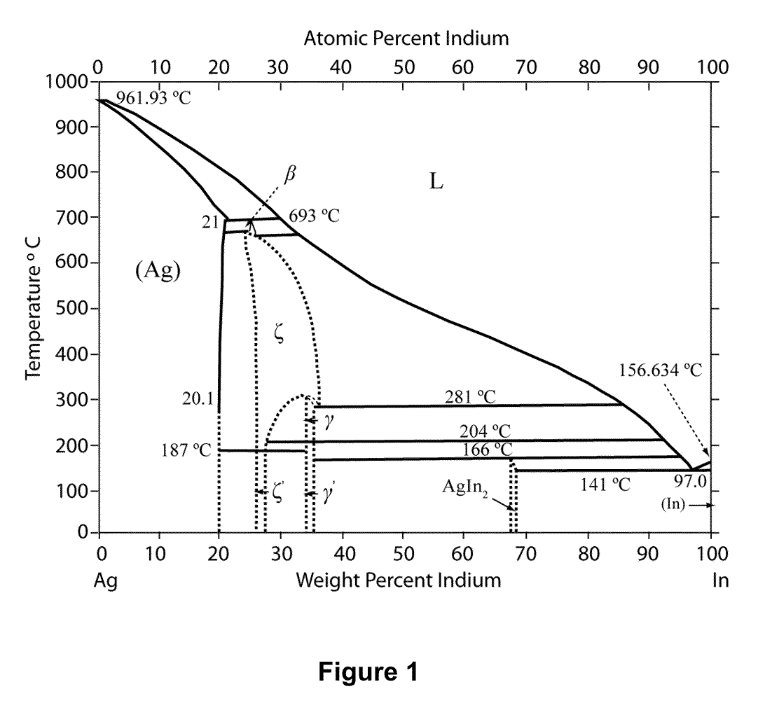

As noted above, the amount or composition of each metal to be provided in the solder material will be based upon the specific metals selected and also factors such as the desired application temperature (Tₐ) range over which the solder material is required to remain stable and perform according to desired specifications. An Ag—In equilibrium phase diagram is depicted in FIG. 1 and provides useful information regarding different melting points of an Ag—In alloy based upon different compositions of Ag and In in the alloy. It is preferable that a Ag—In solder material formed according to the invention will have an In content from about 14% to about 35% by weight of the metal alloy formed in the solder material (i.e., a weight percentage from about 65% to about 86% of Ag in the metal alloy), which would yield a resultant melting point (Tₘ) for the metal alloy that is formed which is significantly higher than the Tₘ value of In.

A powder composition was formed including about 75% Ag and about 25% In by weight of the metal powder. Referring to the phase diagram of FIG. 1, utilizing such a Ag—In ratio will result in the formation of a Ag—In alloy having a resultant melting point (Tₘ) of about 693° C.

The amount of RMA flux material in the solder paste was about 10% by total weight of the paste material (i.e., combined weight of metal powder with flux material).

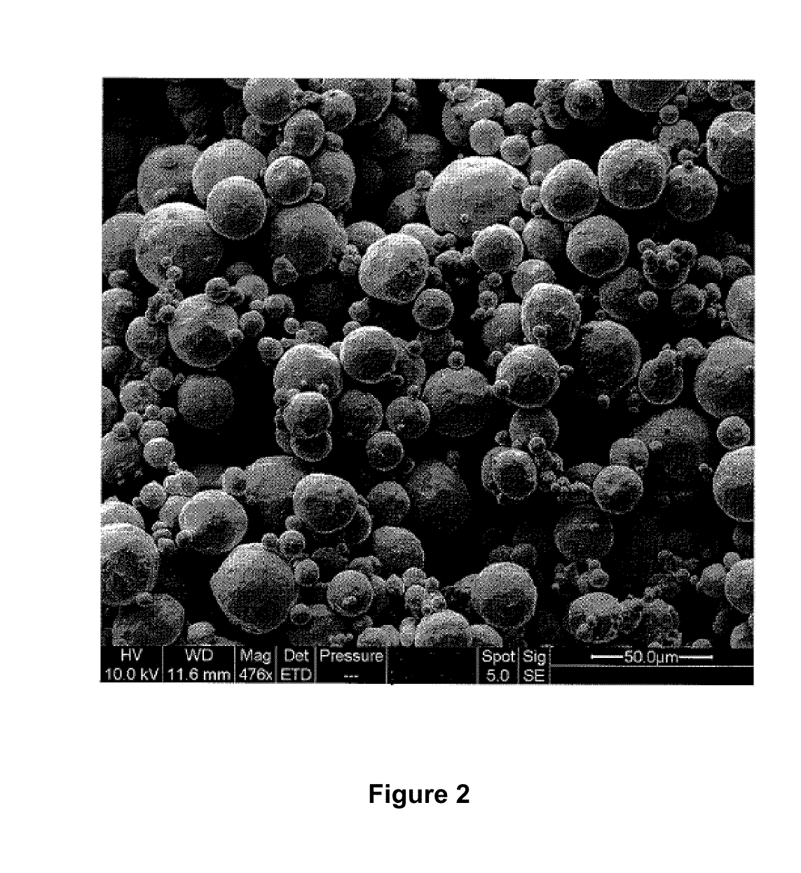

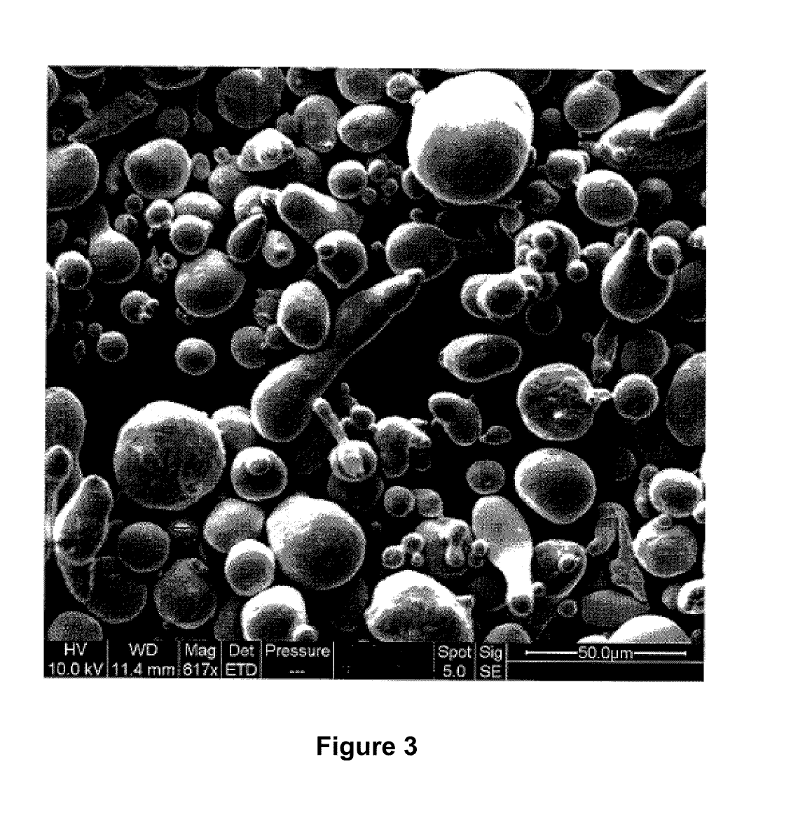

Each of the Ag and In powders included particles having a particle size of (−325/+500) mesh as determined by a standard screening or sieving process. This is equivalent to a particle size of each of the Ag and In particles within the powders of less than 50 microns, where 80% of the particles have sizes from about 25 microns to about 45 microns. FIG. 2 and FIG. 3 depict respective SEM (scanning electron microscope) photographs of Ag and In particles within the powders. As can be seen from the SEM image of FIG. 2, the Ag powder included particles having generally rounded and spherical geometries. The SEM image of FIG. 3 shows that the In powder included particles having generally ligamental geometries. The ligamental geometries of the In particles facilitate the melting of the In particles during the alloy formation process (e.g., due to the increased particle surface area/volume ratio).

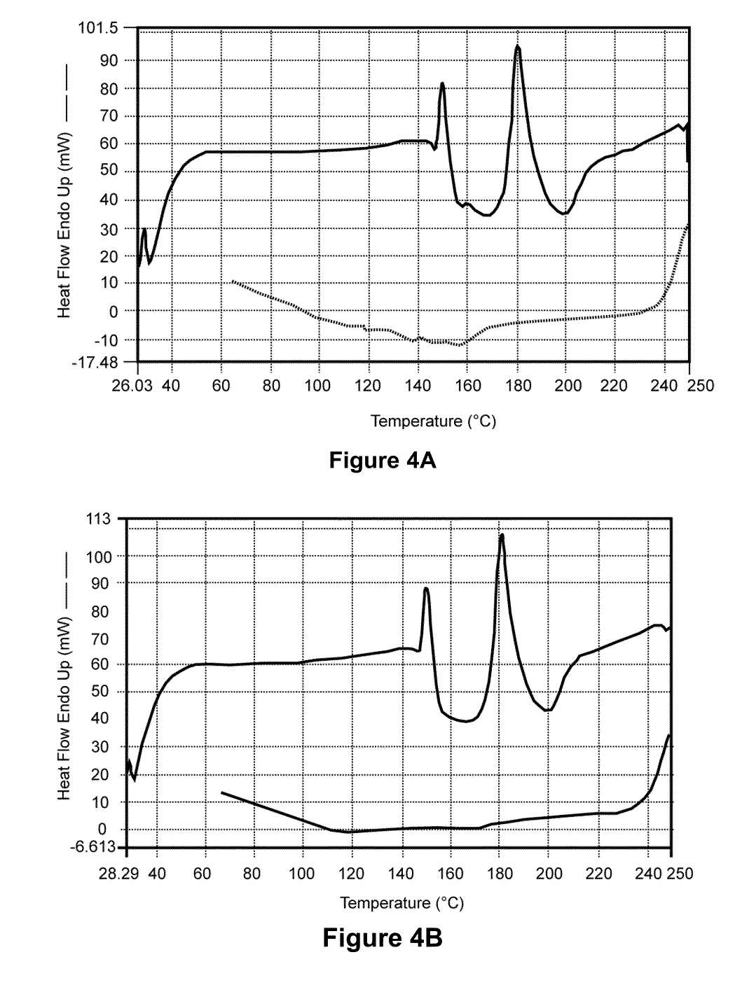

The solder paste material including Ag and In particles was subjected to a TLPS process in the manner described above. A process temperature (Tₚ) for the TLPS process was selected at 250° C. A number of different holding times were utilized, with the resultant alloy solder material being tested to determine to what extent any In rich phase (i.e., higher concentrations of In metal) were present in the resultant solder material. A differential scanning calorimeter (DSC) was used for thermal characterization of the resultant solder materials formed at the different holding times. The results for tests performed at two different holding times are shown in FIG. 4A and FIG. 4B.

In particular, for the first test, the TLPS process was performed with a Tₚ of 250° C. and a holding time of 1 minute. The results of the first test are plotted in FIG. 4A. For the second test, the TLPS process was performed with a Tₚ of 250° C. and a holding time of 60 minutes. The results of the second test are plotted in FIG. 4B. For each test, the TLPS process was performed utilizing the same precursor solder paste material and at a heating rate of about 1° C./second. Each plot in FIG. 4A and FIG. 4B is similar during the heating period, with an initial melting of the In rich phase within the precursor material at about 147° C. (as can be seen by the endothermic peaks shown in the two plots). During the cool down period, an exothermic peak is detected in FIG. 4A, indicating the presence of some percentage of the resultant material containing a low melting point In rich phase. However, no exothermic peak was observed in FIG. 4B, indicating no presence of any low melting point In rich phase and further that In metal had sufficiently diffused within the material via the TLPS process.

These tests show that, for the formation of a Ag—In solder material using the TLPS process and a Tₚ of 250° C., utilizing a holding time of 60 minutes will ensure sufficient diffusion of In into the alloy for the creation of a suitable high temperature solder material that can be used at application temperatures much greater than Tₚ and also the In melting point. In addition, since the melting point of the resultant Ag—In alloy material is about 693° C., the ratio of Tₘ/Tₚ is 2.77.

### Example 2

### Forming a Solder Joint with Ag—In Solder Material

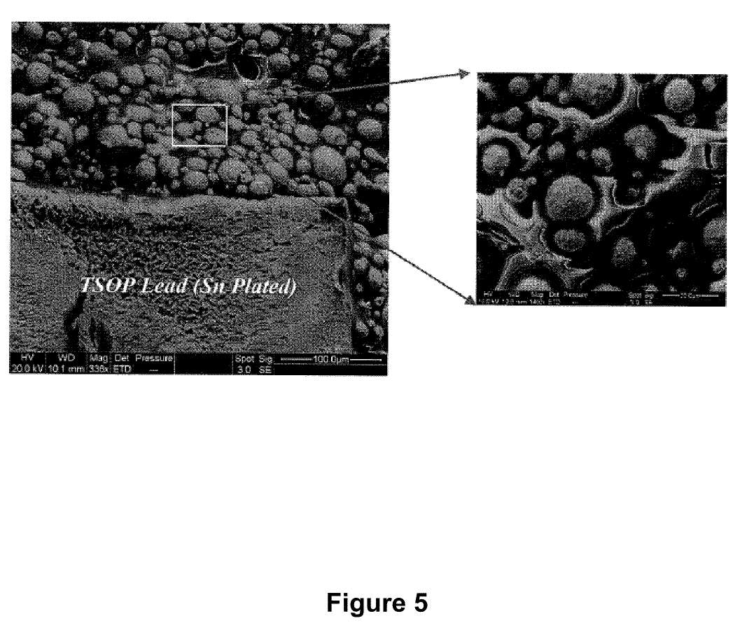

A solder joint was formed using the Ag—In solder paste material described above in Example 1 and with a TLPS process utilizing a Tₚ of 250° C. , a heating rate of about 1° C./second and a holding time of 60 minutes. The solder joint was formed by applying the solder paste material to a substrate on which a TSOP package with pure Sn plated leads was to be attached. The composition of the solder joint that was formed was determined (using EDX spectrum analysis) to be about 75% by weight Ag and 25% by weight In. Any Sn dissolved from the lead finish was of such small quantity as to be undetectable by the analysis. An SEM image of the solder joint that was formed is depicted in FIG. 5. As can be seen, in particular from the magnified view of the soldered joint, generally spherical Ag particles are present and embedded within a Ag—In metal matrix.

The resultant Ag—In metal alloy forming the solder joint had a melting point of about 693° C., and it was determined that the solder joint remained stable and could withstand application temperatures (Tₐ values) as high as at least about 600° C. The Tₘ/Tₚ value for the metal alloy and solder joint is 2.77, and the Tₐ/Tₚ value for this Ag—In metal alloy solder material is 2.4.

As noted above, for a conventional metal solder material to be rated to withstand Tₐ values as high as 600° C., the Tₘ and Tₚ values must be sufficiently higher than this temperature (i.e., the Tₐ/Tₚ value is less than 1). The high processing temperature for such conventional solder materials complicates the manufacturing process and further is potentially detrimental to other materials used to form a device having such a solder joint.

### Example 3

### Effect of Particle Size and Holding Time on Homogenization of Ag—In Solder Material during TLPS Process

Two Ag—In solder paste materials (Paste A and Paste B) were formed in a similar manner as described above in Example 1, with the amount of Ag/In in the metal powder being about 75% Ag and about 25% In of the total metal powder weight and with a no clean RMA flux material being provided to form the paste in an amount of about 10% by total weight of the paste. In the first paste, Paste A, the nominal particle size of both Ag and In particles was limited to no more than about 25 microns (using a (−500/+635) mesh as determined by a standard screening or sieving process, where 80% of the particles are from about 15 microns to about 25 microns). In the second paste, Paste B, the nominal particle size of both Ag and In particles was limited to no more than about 50 microns (using a (−325/+500) mesh as determined by a standard screening or sieving process, where 80% of the particles are from about 25 microns to about 45 microns).

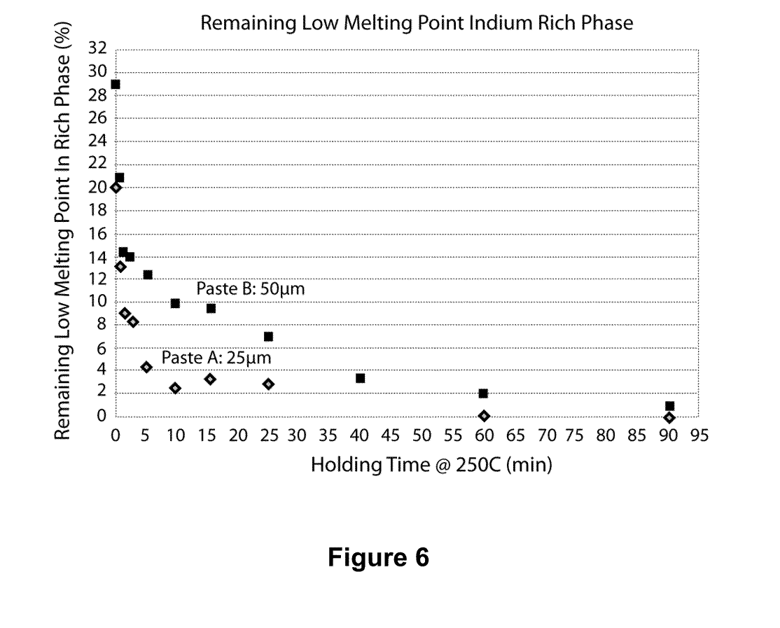

For each of the two pastes, a TLPS process was performed in a similar manner as described above in Example 1, where Tₚ was 250° C. and the heating rate was about 1° C./second. A series of samples of both pastes were thermally treated in the TLPS process at various holding times varying from 1 minute to 90 minutes. The amount of low melting point In rich phase material (wt. %) that remained in the resultant metal alloy solder material after the TLPS process was measured for the different samples using DSC characterization techniques. This data is plotted in FIG. 6.

Referring to FIG. 6, it can be seen that both Paste A and Paste B formed metal alloy solder materials with very low amounts of low melting point In rich phase material with holding times as low as 25 minutes, indicating that both of these pastes would be effective for forming a high temperature solder material for use at application temperatures that are significantly higher than the process temperature of 250° C. In addition, the plotted data shows that, as the holding time is increased, the percentage of low melting point In rich phase material in the resultant metal alloy solder material decreases significantly from 1 minute to 60 minutes, with little or no change observed for Paste A when the holding time was increased from 60 minutes to 90 minutes. The data plotted in FIG. 6 further reveals that the paste with smaller metal particle sizes (Paste A) results in a lower percentage of low melting point In rich phase material within the resultant metal alloy solder material at the same holding times in comparison to the paste having larger metal particle sizes (Paste B).

Thus, this Example shows the effect of particle size and holding time on the resultant metal alloy solder material that is formed.

### Example 4

### Formation of a Solder Joint between a Semiconductor Die and a Substrate using a Ag—In Solder Material

A silver-indium solder paste material was prepared in a similar manner as set forth in Example 1 (75% by weight Ag of the metal powder, 25% by weight In of the metal powder, and using a no clean RMA flux material at about 10% by weight of the paste material). This paste material was applied using a stencil printing technique to areas of a metalized substrate.

The metalized substrate was an alumina (Al₂O₃) substrate (0.625 mm thick) having a directly bonded copper (Cu) layer (0.3 mm thick), a nickel (Ni) layer electrolessly plated over the Cu layer and a Ag layer (1200 nm thick) deposited by physical vapor deposition over the Ni layer. The paste material was applied to areas of the metalized substrate using a stencil in the form of an 8 mil (about 203 micron) thick stainless steel foil having laser cut openings, where the stencil was placed upon the substrate and the paste material coated over the laser cut openings so as to be applied to the substrate surface at the selected areas and locations of the substrate. Thus, the paste was pattern coated onto the substrate surface at a thickness of 8 mils (about 203 microns).

Dummy semiconductor dies were formed comprising silicon substrates metalized with a layer of chromium (Cr) having a thickness of 30 nm, a layer of Ni having a thickness of 150 nm, and a layer of Ag having a thickness of 300 nm. The semiconductor dies were applied to the paste material coated sections of the substrate, with the metalized surfaces of the dies contacting the paste material.

Upon applying the semiconductor dies to the substrate, the substrate was heated using a TLPS process similar to that described above in Example 1 (heating rate of 1° C./second, Tₚ=250° C., and isothermal holding time of 60 minutes). Upon cooling to ambient temperature, the semiconductor dies were effectively secured to the substrate via solder joints consisting of the solder material formed from the paste during the TLPS process. The solder joints had a thickness of about 4 mils (about 102 microns).

The stability of the solder joints was tested to temperatures up to about 600° C., and the solder joints were observed to be stable at such temperatures. Thus, the Ag—In solder joint was effective in maintaining integrity at application temperatures well above the process temperature (i.e., at Tₐ/Tₚ values much greater than 1).

The metal alloy solder materials described herein are highly effective in forming solder joints to bond components together in a device (e.g., an electrical or electronic device). The formation of solder joints can be achieved at low process temperatures, in which the resultant metal alloys that are formed using the precursor materials have melting point temperatures that are much higher than the process temperatures required to form the metal alloys (i.e., Tₘ/Tₚ>1), which facilitates use of the solder materials at application temperatures that are also much higher than the process temperatures used to form the solder materials (i.e., Tₐ/Tₚ>1).

All publications and patents mentioned in this specification are herein incorporated by reference to the same extent as if each individual publication or patent application was specifically and individually indicated to be incorporated by reference in its entirety. While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth.

What is claimed is:

1. A method of forming a solder material, the method comprising:
forming a precursor material comprising a plurality of metal particles including a first metal having a first melting point temperature and a second metal having a second melting point temperature, the first melting point temperature being greater than the second melting point temperature;
heating the precursor material to a process temperature (Tₚ) that is greater than the second melting point temperature and less than the first melting point temperature; and
isothermally holding the precursor material at the process temperature (Tₚ) for a preselected holding period so as to form a metal alloy material including the first and second metals, wherein the metal alloy material has a melting point temperature that is greater than the process temperature.

2. The method of claim 1, wherein the precursor material further includes a binder material combined with the metal particles to form a paste material, wherein said binder material optionally comprises a flux material.

3. The method of claim 1, wherein the precursor material further includes metal particles of a third metal having a third melting point temperature that is less than the first melting point temperature, and the formed metal alloy material further includes the third metal.

4. The method of claim 1, wherein the first metal is one of Ag, Cu, and Au.

5. The method of claim 1, wherein the second metal is one of In, Sn, and Ga.

6. The method of claim 1, wherein the first metal is Ag and the second metal is In.

7. A method of manufacturing a device including forming a solder joint that bonds two components together, the method comprising:
providing a first component and a second component to be bonded together;
applying a precursor material to a surface of the first component, the precursor material comprising a first metal having a first melting point temperature and a second metal having a second melting point temperature, the first melting point temperature being greater than the second melting point temperature;
applying the second component to the surface of the first component including the precursor material;
heating the precursor material to a process temperature (Tₚ) that is greater than the second melting point temperature and less than the first melting point temperature; and
isothermally holding the precursor material at the process temperature (Tₚ) for a preselected holding period so as to form a metal alloy material that bonds the first component to the second component, the metal alloy material having a melting point temperature that is greater than the process temperature.

8. The method of claim 4, wherein the melting point temperature of the formed metal alloy material is greater than a maximum application temperature (Ta) at which the device is specified for use, the application temperature (Ta) is at least about 180° C., and Ta/Tp>1.

9. The method of claim 7, wherein the first metal is one of Ag, Cu, and Au.

10. The method of claim 7, wherein the second metal is one of In, Sn, and Ga.

11. The method of claim 7, wherein the first metal is Ag and the second metal is In.

12. The method of claim 7, wherein the device comprises an electronic device and the first component comprises one of a board, a substrate and an electronic component, and the second component comprises an electronic component.

13. A precursor material used to form a metal alloy solder material, the precursor material comprising metal particles combined with a binder material, the metal particles including a first metal having a first melting point temperature and a second metal having a second melting point temperature, the first melting point temperature being greater than the second melting point temperature, wherein the metal particles have sizes no greater than about 50 microns and wherein the binder material optionally contains a flux material.

14. The precursor material of claim 13, wherein the first metal is one of Ag, Cu, and Au.

15. The precursor material of claim 13, wherein the second metal is one of In, Sn, and Ga.

16. The precursor material of claim 13, wherein the first metal is Ag and the second metal is In.

17. A solder material comprising a metal alloy formed from a plurality of metals including a first metal having a first melting point temperature and a second metal having a second melting point temperature, the first melting point temperature being greater than the second melting point temperature, wherein the metal alloy is formed by combining particles of the first and second metals and heating the metal particles to a process temperature to form the metal alloy, wherein the metal alloy has a melting point temperature that is greater than the second melting point temperature and the process temperature.

18. The solder material of claim 17, wherein the first metal is one of Ag, Cu, and Au.

19. The solder material of claim 17, wherein the second metal is one of In, Sn, and Ga.

20. The solder material of claim 17, wherein the first metal is Ag and the second metal is In.

21. A device comprising a first component bonded to a second component with the solder material of claim 17.

22. The device of claim 21, wherein the device comprises an electronic device and wherein the first component comprises one of a board, a substrate and an electronic component, and the second component comprises an electronic component.
